(19) United States
(12) Patent Application Publication
(10) Pub. No.: US 2010/0143729 A1
(43) Pub. Date: Jun. 10, 2010

(54) Flexible Metal-Clad Laminate Plate

(76) Inventors: Takashi Kikuchi, Hieitsuji Otsu-shi Shiga (JP); Hisayasu Kaneshiro, Shinmeimiyahigashi Uji-shi Kyoto (JP); Shogo Fujimoto, Konooka-cho Otsu-shi Shiga (JP)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/989,851

(22) PCT Filed: Jul. 26, 2006
(86) PCT No.: PCT/JP2006/314728

§ 371 Date: Jan. 31, 2008

(30) Foreign Application Priority Data
Aug. 4, 2005 (JP) 2005-226242

(51) Int. Cl. B32B 15/088

(52) U.S. Cl. 428/458

(57) ABSTRACT

Disclosed is a flexible metal clad laminate plate with good appearance which can be manufactured by a metalizing method such as evaporation coating, sputtering or plating. The flexible metal clad laminate plate has a polyimide film. The polyamide film is produced by reacting an aromatic diamine with an aromatic acid dianhydride to produce a polyamide acid and then imidizing the polyamide. The polyamide film has (A) an inflexion point of the storage modulus falling within the range from 270 to 340° C., (B) the peak top of tan δ; (which is a value given by dividing the loss modulus by the storage modulus) falling within the range from 320 to 410° C., (C) the storage modulus at 400° C. falling within the range from 0.5 to 1.5 GPa, and (D) the storage modulus α₁ (GPa) at the inflexion point and the storage modulus α₂ (GPa) at 400° C. both falling within the range satisfying Formula (1) below

85≧{(α₁−α₂)/α₁}×100≧70. (Formula 1)

### TECHNICAL FIELD

The present invention relates to a flexible metal clad laminate plate that allows improvement in windability of polyimide films in order to reduce defects occurring at the time of forming conductive layers.

### BACKGROUND ART

There have been increasing demands for various printed circuit boards in recent years, as electronics products have become lighter, smaller, and denser. Especially flexible printed circuit boards (hereinafter, sometimes referred to as FPC) have been increasingly demanded. A flexible printed circuit board has a structure in which circuits made of metal foil are formed on insulative films.

Flexible metal clad laminate plates that are to constitute the flexible circuit boards are produced generally as follows. An insulative film made of various insulative materials and having flexibility is used as a substrate. Metal foil is heated and pressed on a surface of the substrate via various adhesive materials to form lamination. Polyimide films and the like are suitably used as the insulative films. Thermoset adhesives of epoxy type, acrylic type and the like are commonly used as the adhesive materials (hereinafter, FPC using the foregoing thermoset adhesives is sometimes referred to as three-layer FPC).

On the other hand, there has been proposed FPC (hereinafter, sometimes referred to as two-layer FPC) having metal layers provided directly on insulative films and/or employing thermoplastic polyimide as adhesive layers. The two-layer FPC has better properties than the three-layer FPC does. Thus, demands for the two-layer FPC are expected to increase.

Exemplary methods for producing the flexible metal clad laminate plates that are to be used in the two-layer FPC include: a casting method including imidization after flow-casting and applying a polyamide acid, which is a precursor of a polyimide, onto metal foil; metallization including forming metal layers directly on polyimide films by vapor deposition, sputtering, plating or the like; and lamination including forming laminates of polyimide films and metal foil via a thermoplastic polyimide. Among those listed above, the casting method and the lamination use metal foil. Thus, the polyimide layers and the metal foil adhere in such a manner that depressions and protrusions on a surface of the metal foil bite into the polyimide layers. Therefore, although adhesive strength is assured, etching residues easily arise at the time of forming wirings by etching. This makes it difficult to form fine wirings. On the contrary, the metallization uses no metal foil. Thus, the metal layers do not come to bite into the insulating layers. Therefore, etching residues are less likely to arise. For this reason, the metallization is suitable for forming fine wirings.

In view of the properties, non-thermoplastic polyimide films are suitably used as the polyimide films used in the metallization. However, the non-thermoplastic polyimides generally need to be imidized under a condition of very high temperature, and strong stress is applied to the films at this time. This sometimes causes looseness or biased stretch in the film obtained. The films having looseness or biased stretch are inferior in windability. Thus, when metallization is carried out in the roll-to-roll step, the metal layers formed may become uneven, or sputtering defects may occur, owing to film wrinkles or film meanders. This sometimes causes deterioration in properties of flexible metal clad laminate plates obtained.

For betterment of looseness and biased stretch of the polyimide films, there has been reported a technique for improvement by drawing gel films (see Patent Literature 1). However, the drawing has problems of increase in equipment cost and difficulty in production of thick films. Therefore, further improvement has been demanded.

### [Patent Literature 1] Japanese Unexamined Patent Publication No. 2004-346210

### DISCLOSURE OF INVENTION

### Technical Problem

The present invention is in view of the foregoing problems, and has as an object to provide a flexible metal clad laminate plate that is reduced in defects occurring at the time of forming a metal layer, by obtaining a polyimide film reduced in looseness and biased stretch.

### Technical Solution

The inventors of the present invention have diligently studied the foregoing problems. As a result, they have found the following to complete the present invention. Specifically, a polyimide film having the storage modulus value controlled to fall within a particular range is allowed to be imidized at relatively low temperature, compared with common polyimide films. This makes it possible to reduce stress applied to the films during the imidization. Thus, it becomes possible to reduce looseness and biased stretch in the film obtained. Use of the polyimide films improves windability, making it possible to obtain a flexible metal clad laminate plate that is reduced in defects occurring at the time of forming metal layers.

Specifically, the object above is attainable with the following new flexible metal clad laminate plates:

(I) A flexible metal clad laminate plate, obtained by directly forming a metal layer at least on a surface of a polyimide film that is used in the flexible metal clad laminate plate, is obtained by imidizing a polyimide acid obtained by causing an aromatic diamine and an aromatic acid dianhydride to react together, and satisfies all of the following conditions (1) to (4):
(1) an inflection point of the storage modulus is within the range of 270° C. to 340° C.;
(2) a peak top of tan δ, which is a value obtained by dividing a loss modulus by the storage modulus, is within the range of 320° C. to 410° C.;
(3) the storage modulus at 400° C. is 0.5 GPa to 1.5 GPa; and
(4) a storage modulus α₁ (GPa) at the inflection point and a storage modulus α₂ (GPa) at 400° C. are within a range defined by Formula (1) below

85≧{(α₁−α₂)/α₁}×100≧70; (Formula 1)

(II) The flexible metal clad laminate plate defined in (I), in which a tensile modulus of the polyimide film is 6 GPa or above;

(III) The flexible metal clad laminate plate defined in (I) or (II), in which the metal layer is directly formed by any one of sputtering, vapor deposition, electrolytic plating, and electroless plating; and

(IV) The flexible metal clad laminate plate defined in any one of (I) to (III), in which a polyimide film having a looseness of 7 mm or below and a biased stretch of 2 mm or below is used.

### EFFECT OF THE INVENTION

A flexible metal clad laminate plate of the present invention uses a polyimide film having a storage modulus that is optimized. This reduces looseness and biased stretch in the films to allow improvement in windability of the films at the time of forming metal layers. It thus becomes possible to reduce defects occurring at the time of forming metal layers, allowing suitable application to FPC on which fine wirings are to be formed.

### BEST MODE FOR CARRYING OUT THE INVENTION

The following describes an embodiment of the present invention. First, a polyimide film according to the present invention is described, on the basis of an embodiment thereof.

(Polyimide Film of the Present Invention)

An aspect of the present inventions is that, if a polyimide film has all of the following properties (1) to (4), looseness and biased stretch in the film are reduced so that it becomes possible to efficiently reduce defects in formation of metal layers at the time of producing the flexible metal clad laminate plates by metallization with the use of the polyimide film:

(1) an inflection point of the storage modulus is within the range of 270° C. to 340° C.;

(2) a peak top of tan δ, which is a value obtained by dividing a loss modulus by the storage modulus, is within the range of 320° C. to 410° C.;

(3) the storage modulus at 400° C. is 0.5 GPa to 1.5 GPa; and

(4) a storage modulus α₁ (GPa) at an inflection point and a storage modulus α₂ (GPa) at 400° C. fall within the range defined by Formula (1) below

85≧{(α₁−α₂)/α₁}×100≧70. (Formula 1)

The following describes the inflection point of the storage modulus. The inflection point of the storage modulus needs to fall within the range of 270 to 340° C., preferably in the range of 290 to 320° C., in view of reducing thermal stress inside an air-heating furnace by which imidization is to be carried out. If the inflection point of the storage modulus is below the range, the polyimide film obtained sometimes deteriorate in thermal resistance or dimension stability at the time when heat is applied. On the other hand, if the storage modulus is above the range, the thermal stress is not sufficiently reduced owing to high softening temperature. Thus, looseness and biased stretch in the film obtained sometimes do not improve.

Further, a peak top of tan δ, which is a value obtained by dividing the loss modulus by the storage modulus, needs to fall within the range of 320° C. to 410° C. or above, preferably in the range of 330° C. to 400° C. If the peak top of tan δ is below the range, the temperature at which tan δ starts increasing becomes approximately 250° C. or lower. This sometimes causes a core layer to start softening during measurement of a dimensional change. Thus, there is a possibility of deterioration in dimensional change at the time when heat is applied. On the other hand, if the peak top of tan δ is above the range, the thermal stress is not sufficiently reduced owing to high softening temperature. Thus, looseness and biased stretch in the film obtained sometimes do not improve.

Further, the storage modulus at 400° C. needs to fall within the range of 0.5 GPa to 1.5 GPa, preferably in the range of 0.6 GPa to 1.3 GPa, and more preferably in the range of 0.7 GPa to 1.2 GPa. If the storage modulus at 400° C. is below the range, the films become so soft in the furnace that the films lose a self-supporting property and ruffle. This sometimes causes deterioration in film appearance. On the other hand, if the storage modulus at 400° C. is above the range, the films do not soften to the level at which the thermal stress is easily reduced. Thus, looseness and biased stretch sometimes do not improve.

Further, the inventors of the present invention have studied a relationship between the storage modulus α₁ (GPa) at the inflection point and the storage modulus α₂ (GPa) at 400° C. As a result, they have found that it is important for improvement in looseness and biased stretch in the films that the storage modulus α₁ (GPa) and the storage modulus α₂ (GPa) fall within the range defined by Formula (1) below

85≧{(α₁−α₂)/α₁}×100≧70 (Formula 1).

If the value is below the range, the degree of reduction in storage modulus is low. Thus, reduction effect is not demonstrated sufficiently, causing no improvement in looseness and biased stretch in the film obtained. On the other hand, if the value is above the range, the films are no longer able to keep the self-supporting property. This causes deterioration in productivity of the films or in appearance of the polyimide film obtained.

In order to obtain a flexible metal clad laminate plate that is reduced in defects occurring at the time of forming the metal layers, a polyimide film that satisfies all of the four conditions above is needed.

Until now, no polyimide film having all of the properties above has been known. The method of obtaining the polyimide film is not particularly limited. The following describes an exemplary method thereof.

The polyimide films of the present invention are obtained from a solution of a polyamide acid, which is a precursor of a polyimide. The polyamide acid is prepared normally by dissolving an aromatic diamine and an aromatic acid dianhydride into an organic solvent so as to be substantially equal in molar quantity. This polyamide acid organic solvent solution thus obtained is stirred under controlled temperature conditions until polymerization of the acid dianhydride and the diamine is completed. This polyamide acid solution is obtained normally with the concentration of 5 to 35 wt %, preferably of 10 to 30 wt %. A suitable molecular weight and a suitable solution viscosity are obtained if the concentration is within the foregoing ranges.

The properties of the polyimide film of the present invention are controllable by controlling not only the structures of the diamine and the acid dianhydride, both of which are raw monomers, but also the order of adding the monomers. Accordingly, to obtain the polyimide film of the present invention, it is preferable to imidize a polyamide acid solution obtained by the following steps (a) to (c).

(a) An aromatic acid dianhydride and an aromatic diamine compound, which is excess in molar quantity with respect to the aromatic acid dianhydride, are caused to react together in an organic polar solvent to obtain a prepolymer having an amino group at respective terminals of the prepolymer.
(b) Thereafter, an additional aromatic diamine compound is added thereto.
(c) Then, an aromatic acid dianhydride is added and polymerized in such a manner that the aromatic acid dianhydride and the aromatic diamine are substantially equimolar in all the steps. Exemplary aromatic diamines usable as the raw monomers of the polyimide film of the present invention include: 4,4′-diaminodiphenylpropane, 4,4′-diaminodiphenylmethane, benzidine, 3,3′-dichlorobenzidine, 3,3′-dimethylbenzidine, 2,2′-dimethylbenzidine, 3,3′-dimethoxybenzidine, 2,2′-dimethoxybenzidine, 4,4′-diaminodiphenylsulfide, 3,3′-diaminodiphenylsulfone, 4,4′-diaminodiphenylsulfone, 4,4′-diaminodiphenyl ether, 3,3′-diaminodiphenyl ether, 3,4′-diaminodiphenyl ether, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl N-methylamine, 4,4′-diaminodiphenyl N-phenylamine, 1,4-diaminobenzene, i.e. p-phenylenediamine, bis{4-(4-aminophenoxy)phenyl}sulfone, bis{4-(3-aminophenoxy)phenyl}sulfone, 4,4′-bis(4-aminophenoxy)biphenyl, 4,4′-is(3-aminophenoxy)biphenyl, bis{4-(4-aminophenoxy)phenyl}propane, 1,3-bis(3-aminophenoxy)benzene, 1,3-bis(4-aminophenoxy)benzene, 1,3-bis(4-aminophenoxy)benzene, 1,3-bis(3-aminophenoxy)benzene, 3,3′-diaminobenzophenone, 4,4′-diaminobenzophenone, analogs thereof and the like. The foregoing aromatic diamines are usable either alone or in arbitrary proportions.

In step (a) above, it is preferable to obtain a prepolymer that forms a block component derived from the thermoplastic polymide. To obtain the prepolymer that forms the block component derived from the thermoplastic polyimide, it is preferable to cause the diamine and the acid dianhydride, both of which have flexibility, to react together. In the present invention, the block component derived from the thermoplastic polyimide is a component that melts at the time when the film of high molecular weight is heated to 400° C. and does not maintain the film shape.

Concretely, it is possible to determine the aromatic diamine compound and the aromatic acid dianhydride component by either confirming whether or not the polyimide obtained by an equimolar reaction of the aromatic diamine compound and the aromatic anhydride component that are used in step (a) melts at the temperature, or confirming whether or not the film shape is maintained. Use of this prepolymer in proceeding reactions in steps (b) and (c) makes it possible to obtain the polyamide acid having thermoplastic portions dispersed in the molecular chain. If the aromatic diamine compound and the aromatic acid dianhydride component that are used in steps (b) and (c) are selected to polymerize the polyamide acid such that the polyimide obtained finally becomes non-thermoplastic, a polyimide film obtained by imidization thereof has thermoplastic portions so that the inflection point of the storage modulus appears in a high-temperature area. On the other hand, since most of the inner part of the molecular chain has non-thermoplastic structure, controlling the ratio of the thermoplastic portions and the non-thermoplastic portions makes it possible to prevent the storage modulus from extremely decreasing in the high-temperature area.

In the present invention, the diamines having flexibility are diamines having flexible structure such as ether group, sulfone group, ketone group, sulfide group and the like, preferably those expressed by General Formula (1) below

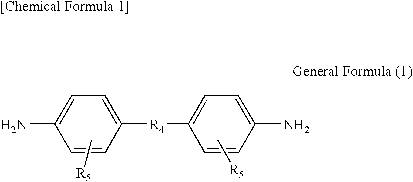

(where R₄ is a group selected from the group consisting of bivalent organic groups each represented by

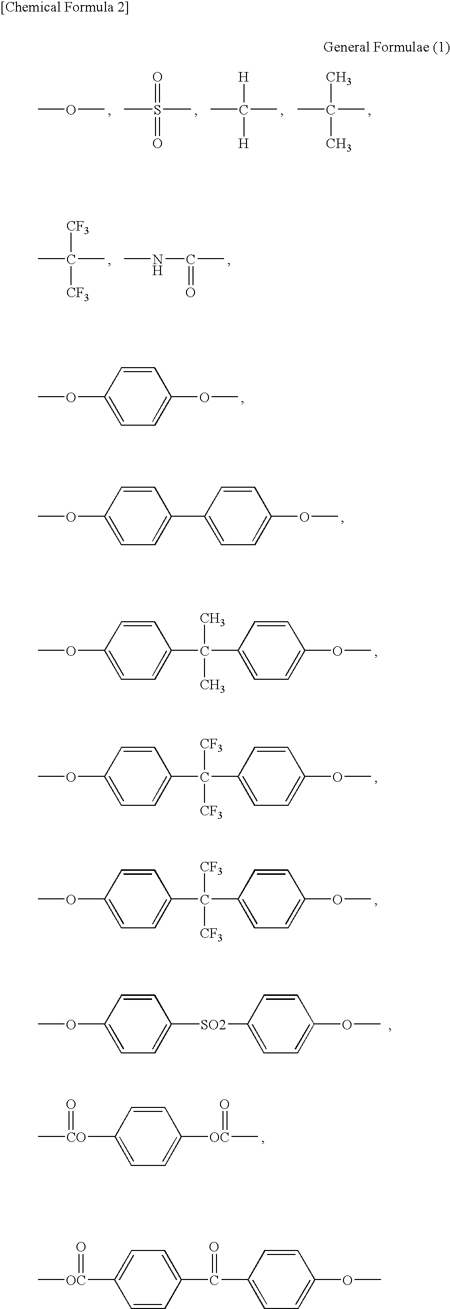

where R₅ is either identical or different and is a group selected from the group consisting of H—, CH₃—, —OH, —CF₃, —SO₄, —COOH, —CO—NH₂, Cl—, Br—, F—, and CH₃O—).

It has not been specifically figured out why the polyimide film obtained by the foregoing steps exhibits high adhesion property although no processing is carried out. It is considered that flexural portions dispersed in the molecular chain either inhibit formation of a fragile surface layer or are somehow involved in adhesion to adhesive layers.

Further, it is preferable that the diamine component used in step (b) be a diamine having rigid structure in order to make a finally-obtained film non-thermoplastic. In the present invention, the diamine having rigid structure is a diamine expressed by

[Chemical Formula 3]

NH₂—R₂—NH₂ General Formula (2)

where R₂ is a group selected from the group consisting of bivalent aromatic groups expressed by

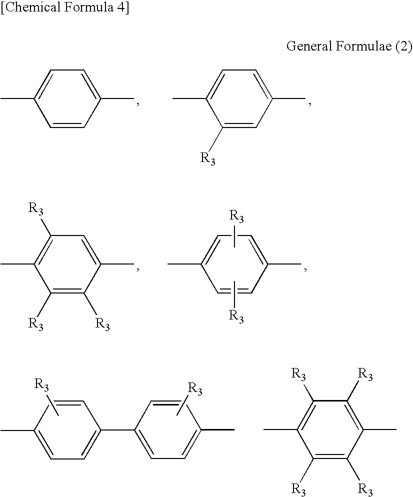

where R₃ is either identical or different and is a group selected from the group consisting of H—, CH₃—, —OH, —CF₃, —SO₄, —COOH, —CO—NH₂, Cl—, Br—, F—, and CH₃O—).

It is preferable to use a diamine having rigid structure and a diamine having flexible structure (diamine having flexibility) at a molar ratio in the range of 80:20 to 20:80, preferably in the range of 70:30 to 30:70, more preferably in the range of 60:40 to 40:60. If the diamine having rigid structure is used at a proportion higher than the foregoing ranges, negative effect sometimes occurs. Specifically, the film obtained becomes too high in glass transition temperature, the storage modulus in the high-temperature area decreases only little, and/or the linear expansion coefficient becomes too small. On the other hand, if the proportion is lower than the foregoing ranges, antithetic negative effect sometimes occurs.

The diamine having flexible structure and the diamine having rigid structure can be used in combination of plural types of the respective diamines. It is, however, especially preferable in the polyimide film of the present invention to use 3,4′-diaminodiphenyl ether as the diamine having flexible structure.

Having only one ether bond, which is a flexural portion, the 3,4′-diaminodiphenyl ether exhibits properties that are between those of the two types of diamines. That is to say, this has effect of reducing the storage modulus but does not increase the linear expansion coefficient that much. Accordingly, combination with a diamine having many flexural portions, such as 1,3-bis(3-aminophenoxy)benzene, bis{4-(4-aminophenoxy)phenyl}propane facilitates balancing the properties of the polyimide film obtained.

It is preferable that the usage of the 3,4′-diaminodiphenyl ether be 10 mol % or above with respect to the whole diamine component, more preferably 15 mol % or above. If the usage is below the foregoing, the effect above may not be produced sufficiently. On the other hand, it is preferable that the upper limit thereof be 50 mol % or below, more preferably 40 mol % or below. If the usage is above the foregoing, the tensile modulus of the polyimide film obtained may become low.

Exemplary acid dianhydrides usable as the raw monomers of the polyimide films of the present invention include pyromellitic acid dianhydride, 2,3,6,7-naphthalenetetracarboxylic acid dianhydride, 3,3′,4,4′-biphenyltetracarboxylic acid dianhydride, 1,2,5,6-naphthalenetetracarboxylic acid dianhydride, 2,2′,3,3′-biphenyltetracarboxylic acid dianhydride, 3,3′,4,4′-benzophenonetetracarboxylic acid dianhydride, 2,2′,3,3′-benzophenonetetracarboxylic acid dianhydride, 4,4′-oxyphthalic acid dianhydride, 3,4′-oxyphthalic acid dianhydride, 2,2-bis(3,4-dicarboxyphenyl)propane dianhydride, 3,4,9,10-perylenetetracarboxylic acid dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)ethane dianhydride, oxydiphthalic acid dianhydride, bis(3,4-dicarboxyphenyl) sulfone dianhydride, p-phenylenebis(trimellitic acid monoester acid anhydride), ethylenebis(trimellitic acid monoester acid anhydride), bisphenol-Abis(trimellitic acid monoester acid anhydride) and analogs thereof and the like. Those listed above are usable either alone or in a mixture of arbitrary proportion.

In the same manner as in the case of the diamine, the acid dianhydrides are classified into those having flexible structure and those having rigid structure. The former is used in step (a), and the latter is used in step (c). Exemplary preferred acid dianhydrides used in step (a) include benzophenone tetracarboxylic acid dianhydrides, oxyphthalic acid dianhydrides, and biphenyl tetracarboxylic acid dianhydrides. Exemplary preferred acid dianhydrides used in step (c) include pyromellitilic acid dianhydride. Further, it is preferable that the usage of each of benzophenone tetracarboxylic acid dianhydrides, oxyphthalic acid dianhydrides, and biphenyltetracarboxylic acid dianhydrides be 10 to 50 mol % with respect to the whole acid dianhydride, preferably 15 to 45 mol %, and more preferably 20 to 40 mol %. If the usage is below the foregoing ranges, the glass transition temperature of the polyimide film obtained sometimes becomes too high, or the storage modulus in the high-temperature area sometimes does not decrease sufficiently, with the diamine having flexible structure alone. On the other hand, if the usage is above the foregoing ranges, the glass transition temperature or the storage modulus in the high-temperature area becomes so low that forming the films sometimes becomes difficult.

The preferred usage in the case in which the pyromellitilic acid dianhydride is to be used is 40 to 100 mol %, preferably 50 to 90 mol %, and more preferably 60 to 80 mol %. Use of the pyromellitilic acid dianhydride within the foregoing ranges makes it easy to maintain both the glass transition temperature of the polyimide film obtained and the storage modulus in the high-temperature area within the range suitable for the use or forming the films.

Employment the types and the compounding ratio of the aromatic acid dianhydride and the aromatic diamine within the foregoing ranges allows the polyimide film of the present invention to exhibit a desired glass transition temperature and a desired storage modulus in the high-temperature area. In view of handling the films, it is preferable that the tensile modulus be 6.0 GPa or above, preferably 6.5 GPa or above. It is preferable that the upper limit of the tensile modulus be 10 GPa or below, preferably 9.0 GPa or below. If the tensile modulus is above the upper limit, the body of the polyimide film sometimes becomes too strained, bringing a problem in handling the film. The tensile modulus increases as the ratio of either the diamine having rigid structure or the acid dianhydride having rigid structure is raised, and decreases as the ratio is reduced.

To increase the tensile modulus, rigid molecular structure has been employed throughout the polyimide conventionally. As a result, the thermal stress in the furnace is reduced only little. Thus, looseness and biased stretch occur easily in the film obtained. The inventors of the present invention have diligently studied and finally come to introduce rigid portions and flexible portions in the structure, thereby achieving reduction of thermal stress in the furnace and obtaining a film having a high tensile modulus.

Regarding the linear expansion coefficient of the polyimide film, it is preferable in terms of the use in FPC that the difference between the polyimide film and the metal layer in linear expansion coefficient be small in view of warpage and dimension stability. It is therefore preferable that the linear expansion coefficient of the polyimide film obtained be 20 ppm/° C. or below at 100° C. to 200° C., more preferably 16 ppm/° C. or below. It should be noted, however, that if the linear expansion coefficient is too small, the difference in linear expansion coefficient of the metal foil also increases. It is therefore preferable that the lower limit of the linear expansion coefficient be 7 ppm/° C., more preferably 9 ppm/° C. The linear expansion coefficient of the polyimide film is adjustable using the mixture ratio of a flexible structure component and a rigid structure component.

Any solvent is usable as the solvent suitable for synthesizing the polyamide acid, as long as it dissolves the polyamide acid. Amide solvents such as N,N-dimethylformamide,N,N-dimethylacetamide, N-methyl-2-pyrrolidone and the like are usable. Especially N,N-dimethylformamide and N,N-dimethylacetamide are usable suitably.

Further, it is also possible to add a filler for the purpose of improving the properties of the films, such as sliding property, thermal conductive property, conductive property, corona resistance, loop stiffness and the like. Anything may be used as the filler. Preferred exemplary fillers include silica, titanium oxide, alumina, silicon nitride, boron nitride, calcium hydrogen phosphate, calcium phosphate, mica and the like.

A particle size of the filler is determined according to the type of a film property that needs to be improved and a type of the filler that is to be added. The particle size is not particularly limited, but it is generally preferable that the average particle size be in the range of 0.05 to 100 μm, preferably in the range of 0.1 to 75 μm, more preferably in the range of 0.1 to 50 μm, and most preferably in the range of 0.1 to 25 μm. With the particle size below the foregoing ranges, improvement effect is less likely to be produced. With the particle size above the foregoing ranges, surface nature sometimes deteriorates significantly or mechanical properties sometimes decrease significantly.

The quantity of filler to be added is also determined according to the film property that needs to be improved, the filler particle size and the like. The quantity of filler is not particularly limited. It is generally preferable that the quantity of filler to be added be in the range of 0.01 to 100 parts by weight with respect to polyimide of 100 parts by weight, preferably in the range of 0.01 to 90 parts by weight, and more preferably in the range of 0.02 to 80 parts by weight. With the quantity below the foregoing ranges, improvement effect by the filler is less likely to be produced. With the quantity above the foregoing ranges, there is a possibility that the mechanical properties of the films deteriorate significantly. To add the filler, any method is usable, such as: (1) a method in which, before or during polymerization, the filler is added to a polymerization reaction liquid; (2) a method in which, after completion of polymerization, the filler is kneaded with a three-roller or the like; and (3) a method in which a dispersion liquid containing the filler is prepared and mixed into a polyamide acid organic solvent solution. Mixing dispersion liquid containing the filler with a polyamide acid solution, especially mixing them immediately before film formation, is preferred because this causes the least contamination of production lines by the filler. It is preferable that the dispersion liquid containing the filler be prepared with the use of a same solvent as a polymerization solvent of the polyamide acid. To suitably disperse the filler and to make a dispersion state stable, it is possible to use a dispersant, a viscosity improving agent or the like to the extent that causes no effect on the film properties.

To make the polyimide films from the foregoing polyamide acid solution, conventional publicly-known methods are employable. Exemplary methods thereof include thermal imidization and chemical imidization. The thermal imidization is a method that promotes the imidization only by heating only without causing a dehydration ring-closing agent or the like to act. The chemical imidization is a method that promotes the imidization by causing a chemical inverting agent and/or a catalyst to act on a polyamide acid solution.

The chemical inverting agent means a dehydration ring-closing agent for polyamide acid. Exemplary chemical inverting agent include aliphatic anhydride, aromatic anhydride, N,N′-dialkyl carbodiimide, halogenated lower aliphatics, halogenated lower aliphatic anhydride, arylphosphonic acid dihalogenide, and mixture of two or more types of those listed above. In view of easiness of acquisition and cost, aliphatic anhydrides such as acetic anhydride, propionic acid anhydride, butyric acid anhydride and the like or a mixture of two or more types of those listed above are suitably usable.

The catalyst means a component that produces effect of promoting dehydration ring-closure effect with respect to the polyamide acid. For example, aliphatic tertiary amine, aromatic tertiary amine, heterocyclic tertiary amine and the like are used. In view of reactivity as catalyst, especially a catalyst selected from the heterocyclic tertiary amines is favorably used. Concretely, quinoline, isoquinoline, β-picoline, pyridine and the like are used suitably.

Either one of the methods can be employed to produce the films, but the polyimide films having the properties used suitably in the present invention are more likely to be obtained easily with the chemical imidization.

Further, it is especially preferable that a method of producing a polyimide film in accordance with the present invention include:
(a) causing an aromatic diamine and an aromatic tetra carboxylic acid dianhydride to react together in an organic solvent to obtain a polyamide acid solution;
(b) flow-casting, on a support medium, film-forming dope containing the polyamide acid solution;
(c) peeling off the gel film from the support medium after heating it on the support medium; and
(d) further adding heat to imidize and dry the remaining amic acid.

In the steps above, it is possible to use a curing agent containing a dehydrating agent, exemplified by acid anhydride such as acetic acid anhydride, and an imidizing catalyst, exemplified by tertiary amines or the like such as isoquinoline, β-picoline, pyridine and the like.

The following describes the steps in producing the polyimide film, taking chemical imidization, which is a preferred embodiment of the present invention, as an example. It should be noted that the present invention is not to be limited to what is discussed below. Conditions for film formation and heat application may vary according to the types of the polyamide acids, film thickness and the like.

A dehydrating agent and an imidizing catalyst were mixed into a polyamide acid solution at low temperature to obtain film-forming dope. This is followed by casting, in the shape of a film, this film-forming dope on a support medium such as a glass plate, aluminum foil, an endless stainless steel belt, and a stainless steel drum. The film-forming dope is heated, on the support medium, at a temperature in the range of 80° C. to 200° C., preferably in the range of 100° C. to 180° C., to activate the dehydrating agent and the imidizing catalyst, thereby being partially cured and/or dried. Thereafter, the film-forming dope is peeled off from the support medium, whereby a polyamide acid film (hereinafter, gel film) is obtained.

The gel film was at an intermediate level in hardening from polyamide acid to polyimide and was self-supporting, and volatile content calculated by Formula 2 below

(A−B)×100/B (Formula 2),

(where A is a weight of the gel film and B is a weight after the gel film has been heated at 450° C. for 20 minutes)
was in the range of 5 to 500% by weight, preferably in the range of 5 to 200% by weight, and more preferably in the range of 5 to 150% by weight. Use of the films within the foregoing ranges is preferable. Use of films out of the foregoing ranges may lead to defects such as unevenness in film color tones, variations in film properties and the like due to film breakage and/or uneven drying during baking.

The preferred amount of dehydrating agent is 0.5 to 5 mol, preferably 1.0 to 4 mol, with respect to a 1-mol unit of the amide acid in the polyamide acid.

Further, the preferred amount of imidizing catalyst is 0.05 to 3 mol, preferably 0.2 to 2 mol, with respect to a 1-mol unit of the amide acid in the polyamide acid.

If the dehydrating agent and the imidizing catalyst fall below the foregoing ranges, chemical imidization becomes insufficient. This sometimes causes breakage during baking or reduction in mechanical strength. Further, if those amounts are above the foregoing ranges, the imidization is sometimes developed so fast that casting into the shape of a film becomes difficult. Thus, this is not preferable.

The gel film is dried while end parts of the gel film are stabilized to avoid shrinkage during curing. Water, residual solvent, residual inverting agent, and catalyst are eliminated. The remaining amide acid is imidized completely. As a result, a polyimide film of the present invention is obtained.

At this time, it is preferable to add heat at a final temperature of 400 to 550° C. for 5 to 400 seconds. Adding the heat higher than the foregoing temperature and/or longer the foregoing period may cause a problem of thermal deterioration of the films. On the other hand, adding the heat lower than the foregoing temperature and/or shorter than the foregoing period may not produce the predetermined effect.

Although exact reasons are not known, the polyimide films having the flexible structure and the rigid structure as described above allows the imidization to be completed at relatively low temperature, compared with common non-thermoplastic polyimide films. This makes it possible to reduce thermal stress applied to the films. Thus, the appearance of the film obtained is easily improved.

To reduce residual internal stress in the films, it is possible to carry out heating treatment under a minimum tension necessary for winding the film. The heat treatment is carried out in the step of producing the film, or an additional step of the heat treatment is included. Heating conditions vary according to film properties and devices used. Therefore, it is not possible to determine the heating conditions uniquely. Generally, it is possible to reduce the internal stress by heat treatment carried out for approximately 1 to 300 seconds, preferably 2 to 250 seconds, more preferably 5 to 200 seconds, at a temperature approximately in the range of 200° C. to 500° C., preferably in the range of 250° C. to 500° C., more preferably in the range of 300° C. to 450° C.

Methods and conditions are not particularly limited in the case in which the metal layer is to be provided on the polyimide film by metallization. Any one of vapor deposition, sputtering, and plating is usable. It is also possible to combine the methods above.

As described above, etching the metal foil to form a desired pattern allows the flexible metal clad laminate plate of the present invention to be used as a flexible wiring board on which various components reduced in size and increased in density are mounted. Needless to say that application of the present invention is not limited to those discussed above, and the present invention is applicable in various ways as long as it is a laminate containing metal foil.

### EXAMPLE

The following concretely describes the present invention with reference to Examples. It should be noted that the present invention is not to be limited to the Examples.

The storage modulus, the tensile modulus, the looseness, the biased stretch, and the linear expansion coefficient of the polyimide film of the Examples and Comparative Examples, and the strength in peeling off the metal foil and the appearance of the flexible metal clad laminate plate of the Examples and Comparative Examples were evaluated as follows.

### (Storage Modulus)

The storage modulus was measured with the use of DMS6100 manufactured by SII NanoTechnology Inc. This measurement was carried out in the MD direction of the core film.

Range of sample measurement: 9-mm width, 20-mm distance between nippers

Range of temperature measurement: 0 to 440° C.

Rate of temperature increase: 3° C./minute

Strain amplitude: 10 μm

Measurement frequency: 1, 5, 10 Hz

Least tension/compression force: 100 mN

Tension/compression gain: 1.5

Initial force amplitude: 100 mN

### (Tensile Modulus)

The tensile modulus was measured in accordance with ASTM D882. This measurement was carried out in the MD direction of the core film.

Range of sample measurement: 15-mm width, 100-mm distance between nippers

Drawing speed: 200 mm/min

### (Film Looseness)

The amount of looseness of the film was measured as follows in accordance with JPCA-BM01. A polyimide film obtained in the Example was placed on two rollers positioned apart from each other. One end of the polyimide film was stabilized, and load was applied to the other end of the polyimide film. At this time, a sag from the horizontal line in the transverse direction (TD) of the film was measured with a scale, with the weight of the film being 5 g. The load was 3 kg/m, and the distance between the rollers was 2 m. The measurement was carried out at the center therebetween.

The value of looseness in the transverse direction was measured at every 50 mm from the point distanced by 10 mm from one end part of the film, and measured up to the point distanced by 10 mm from the other end of the film. The largest one of the values was defined as the amount of looseness.

### (Biased Stretch)

The biased stretch of the film was measured as follows. First, the polyimide film obtained was cut into the size of 500 mm, in the transverse direction (TD), by 6 m, in the moving direction (MD), whereby strips of film were obtained. The film thus obtained was placed on a flat surface to draw a straight line connecting both ends of a side in the moving direction. Then, a straight line was drawn, at a central area (3 m) in the moving direction, parallel to the transverse direction. The distance between the intersection of those two lines and the point at which the latter straight line intersects with the film was defined as the value of the biased stretch.

### (Linear Expansion Coefficient)

The linear expansion coefficient of the polyimide film was measured as follows. The polyimide film was first heated with a thermal mechanical analyzer manufactured by SII NanoTechnology Inc. (product name: TMA/SS6100) from 0° C. to 400° C., and then cooled down to 10° C. Thereafter, the temperature was raised by 10° C./min, and a mean value in the range of 100 to 200° C. at the time when the temperature was raised for the second time was obtained. This measurement was carried out both in the MD and TD directions of the core film.

Shape of sample: 3-mm width, 10-mm length

Load: 29.4 mN

Range of temperature measurement: 0 to 460° C.

Rate of temperature increase: 10° C./min

### (Strength in Peeling Off the Metal Layer: Adhesive Strength)

A sample was prepared in accordance with “6.5: Strength in peeling off” of JIS C6471. Metal foil having the width of 5 mm was peeled off by a peel angle of 90 degrees at 50 mm/minute, and the load thereof was measured. The total 18 pieces of evaluation samples for the adhesive strength were extracted, three pieces in the transverse direction of the metal clad laminate plate and six pieces in the moving direction of the metal clad laminate plate. A mean value thereof was defined as the adhesive strength.

### (Appearance of Metal Clad Laminate Plate)

The appearance of the metal clad laminate plate was evaluated by visual inspection with the use of a magnifying glass. The case in which there are two or fewer pinholes due to wrinkles, sputtering, or plating defects within a 100 m² area was classified as “GOOD”. The case of 3 to 5 pinholes was classified as “AVERAGE”. The case of 6 or more pinholes was classified as “POOR”.

### Examples 1 to 3

### Synthesis of Polyimide Film

With the inside of the reaction system being maintained at 5° C., 3,4′-diaminodiphenyl ether (hereinafter, sometimes referred to as 3,4′-ODA) and bis{4-(4-aminophenoxy)phenyl}propane (hereinafter, sometimes referred to as BAPP) were added to N,N-dimethylformamide (hereinafter, sometimes referred to as DMF) at the molar ratio shown on Table 1 and stirred. After it had been visually confirmed that they had been dissolved, benzophenonetetracarboxylic acid dianhydride (hereinafter, sometimes referred to as BTDA) was added at the molar ratio shown on Table 1, and stirred for 30 minutes.

Then, pyromellitic acid dianhydride (hereinafter, sometimes referred to as PMDA) was added at the molar ratio shown on Table 1, and then stirred for 30 minutes. Thereafter, p-phenylenediamine (hereinafter, sometimes referred to as p-PDA) was added at the molar ratio shown on Table 1, and then stirred for 50 minutes. Thereafter, another PMDA was added at the molar ratio shown on Table 1, and then stirred for 30 minutes.

At the end, a solution was prepared by dissolving 3 mol % of PMDA into DMF in such a manner that the concentration of the solid content was brought to 7%. This solution was gradually added to the reaction solution, with attention paid to increase in viscosity. Polymerization was stopped at the time when the viscosity at 20° C. reached 4000 poises.

To this polyamide acid solution, an imidization promoting agent made from acetic acid anhydride/isoquinoline/DMF (ratio by weight: 2.0/0.3/4.0) was added at the ratio by weight of 45% with respect to the polyamide acid solution, stirred continuously with a mixer, extruded from a T-die to be flow-cast on an endless belt made of stainless steel and running 20 mm below the die. This resin layer was heated at 130° C. for 100 seconds. Thereafter, the gel film having a self-supporting property was peeled off from the endless belt (volatile content 30% by weight), fixed to a tenter clip, dried at 250° C. for 100 seconds, at 360° C. for 120 seconds, and at 450° C. for 110 seconds to be imidized. Then, a polyimide film having the thickness of 35 μm was wound.

The polyimide film obtained was unwound, and plasma treatment with argon ion was carried out on one surface of the polyimide film as a pre-treatment, whereby unnecessary organic matter or the like on the surface was eliminated. Then, a laminate of nickel having the thickness of 50 Angstroms was formed by sputtering, and then a laminate of copper having the thickness of 2000 Angstroms was formed on the nickel, whereby a metal laminate was produced. Then, a laminate of a copper plated layer was formed on the surface by copper sulfate electric plating (cathode current density of 2A/dm2, plating thickness of 20 μm, 20 to 25° C.), whereby a metal laminate was produced.

### Comparative Example 1

With the inside of the reaction system being kept at 5° C., 4,4′-diaminodiphenyl ether (hereinafter, sometimes referred to as 4,4′-ODA) and PMDA were mixed into N,N-dimethylformamide (hereinafter, sometimes referred to as DMF) at the molar ratio 100:97, and then stirred for 30 minutes. Thereafter, a solution was prepared by dissolving 3 mol % of PMDA into DMF in such a manner that the concentration of the solid content was brought to 7%. This solution was gradually added to the reaction solution, with attention paid to increase in viscosity. Polymerization was stopped at the time when the viscosity at 20° C. reached 4000 poises.

To this polyamide acid solution, an imidization promoting agent made from acetic anhydride/isoquinoline/DMF (ratio by weight: 2.0/0.3/4.0) was added at the ratio by weight of 45% with respect to the polyamide acid solution, stirred continuously with a mixer, extruded from a T-die to be flow-cast on an endless belt made of stainless steel and running 20 mm below the die. This resin layer was heated at 130° C. for 100 seconds. Thereafter, the self-supporting gel film was peeled off from the endless belt (volatile content: 30% by weight), fixed to a tenter clip, and dried at 300° C. for 100 seconds, at 450° C. for 120 seconds, and at 500° C. for 110 seconds to be imidized. Then a polyimide film having the thickness of 35 μm was wound.

The same operations as those in the Examples were carried out with the use of the polyimide film thus obtained, whereby the metal laminate was produced.

### Comparative Example 2

In the same manner as in Example 1, the materials are caused to react at the molar ratio as shown on Table 1, whereby a polyamide acid solution was obtained. With the use of the polyamide acid solution, a polyimide film having the thickness of 35 μm was obtained.

The same operations as those in the Examples were carried out with the use of the polyimide film thus obtained, whereby the metal laminate was produced.

Results of evaluation of properties of the polyimide films and metal laminates obtained in the respective Examples and Comparative Examples are as shown on Tables 2 and 3.

TABLE 1

| | 3,4′- | | | PMDA | | PMDA |
|---|---|---|---|---|---|---|
| | ODA | BAPP | BTDA | (FIRST) | p-PDA | (SECOND) |
| Example 1 | 10 | 40 | 10 | 35 | 50 | 52 |
| Example 2 | 30 | 25 | 15 | 35 | 45 | 47 |
| Example 3 | 25 | 30 | 25 | 15 | 45 | 57 |
| Comparative | 10 | 50 | 10 | 45 | 40 | 42 |
| Example 2 | | | | | | |

TABLE 2

| | INFLECTION | STORAGE | | | | | | LINEAR | |
|---|---|---|---|---|---|---|---|---|---|
| | POINT OF | MODULUS | TANδ | | | AMOUNT | | EXPANSION | |
| | STORAGE | AT | PEAK- | {(α₁ − α₂)/ | TENSILE | OF | BIASED | COEFFICIENT | |
| | MODULUS | 400° C. | TOP | α₁} × | MODULUS | LOOSENESS | STRETCH | (ppm/° C.) | |
| | (° C.) | (GPa) | (° C.) | 100 | (GPa) | (mm) | (mm) | MD | TD |
| EXAMPLE 1 | 300 | 0.7 | 360 | 72 | 5.2 | 6 | 1 | 17 | 17 |
| EXAMPLE 2 | 295 | 0.9 | 346 | 80 | 6.8 | 5 | 0.5 | 15 | 14 |
| EXAMPLE 3 | 278 | 0.6 | 323 | 84 | 6.8 | 5 | 1 | 15 | 15 |
| COMPARATIVE | — | 1.8 | — | — | 3.1 | 8 | 4 | 30 | 31 |
| EXAMPLE 1 | | | | | | | | | |
| COMPARATIVE | 290 | 0.25 | 335 | 90 | 4.8 | 10 | 5 | 24 | 25 |
| EXAMPLE 2 | | | | | | | | | |

α1: storage modulus (GPa) at the inflection point
α2: storage modulus (GPa) at 400° C.
Properties of the core films used as the adhesive films in Comparative Examples are described

TABLE 3

| | ADHESIVE | |
|---|---|---|
| | STRENGTH | |
| | (N/cm) | APPEARANCE |
| EXAMPLE 1 | 8.0 | GOOD |
| EXAMPLE 2 | 8.5 | GOOD |
| EXAMPLE 3 | 9.2 | GOOD |
| COMPARATIVE | 2.5 | POOR |
| EXAMPLE 1 | | |
| COMPARATIVE | 2.0 | POOR |
| EXAMPLE 2 | | |

As illustrated by Comparative Examples 1 and 2, the amount of looseness and the value of the biased stretch of the polyimide films become high if the storage modulus and the peak of tan δ are out of the respective defined ranges. In this case, windability deteriorates. This causes unevenness in lamination and the like occur during sputtering and plating. Thus, a metal laminate that is low in adhesive strength and inferior in appearance is produced.

On the contrary, the metal laminates of the Examples using the polyimide films having all properties that are within the predetermined ranges show no problem both in adhesive strength and appearance.

### INDUSTRIAL APPLICABILITY

A flexible metal clad laminate plate of the present invention employs a polyimide film having a storage modulus that is optimized, whereby looseness and biased stretch of the films are reduced to allow improvement in windability of films at the time of forming metal layers. This makes it possible to reduce defects occurring at the time of forming metal layers, allowing suitable application to FPC on which fine wirings are to be formed.

1. A flexible metal clad laminate plate, obtained by directly forming a metal layer at least on a surface of a polyimide film that is used in the flexible metal clad laminate plate, is obtained by imidizing a polyimide acid obtained by causing an aromatic diamine and an aromatic acid dianhydride to react together, and satisfies all of the following conditions (1) to (4):
(1) an inflection point of the storage modulus is within the range of 270° C. to 340° C.;
(2) a peak top of tan δ, which is a value obtained by dividing a loss modulus by the storage modulus, is within the range of 320° C. to 410° C.;
(3) the storage modulus at 400° C. is 0.5 GPa to 1.5 GPa; and
(4) a storage modulus α₁ (GPa) at the inflection point and a storage modulus α₂ (GPa) at 400° C. are within a range defined by Formula (1) below
85≧{(α₁−α₂)/α₁}×100≧70. (Formula 1)

2. The flexible metal clad laminate plate of claim 1, wherein a tensile modulus of the polyimide film is 6 GPa or above.

3. The flexible metal clad laminate plate of claim 1, wherein the metal layer is directly formed by any one of sputtering, vapor deposition, electrolytic plating, and electroless plating.

4. The flexible metal clad laminate plate of claim 1, wherein a polyimide film having a looseness of 7 mm or below and a biased stretch of 2 mm or below is used.
